(19) United States
(12) Patent Application Publication
(10) Pub. No.: US 2007/0175337 A1
(43) Pub. Date: Aug. 2, 2007

(54) Beverage system for dispensing a homogeneous beverage and a method for dispensing a beverage

(75) Inventors: David Nicholas Fedorchak, Woodbridge, NJ (US); John William Tobin, Hillsdale, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a Unilever

(21) Appl. No.: 11/344,318

(22) Filed: Jan. 31, 2006

(51) Int. Cl. A47J 31/00

(52) U.S. Cl. 99/279

(57) ABSTRACT

A beverage system for dispensing a homogeneous beverage is described. The beverage system has a mixing chamber with at least two mixing chamber housings for solvents of different temperatures. Beverage precursor provided to the mixing chamber is mixed via turbulent flow of solvents within the mixing chamber to yield a homogeneous beverage deplete of particles of undissolved precursor.

### FIELD OF THE INVENTION

The present invention is directed to a beverage system for dispensing a homogeneous beverage and a method for dispensing a beverage. More particularly, the present invention is directed to a beverage system having a mixing chamber for mixing beverage precursor with heated solvent whereby the mixing occurring within the mixing chamber is the result of turbulent flow created within the same. Surprisingly, the present invention results in the dispensing of a beverage that has homogeneous characteristics throughout the duration of the dispensing period. Moreover, the beverage system for dispensing a beverage according to this invention surprisingly results in a beverage with less haze than beverage produced in conventional beverage systems.

### BACKGROUND OF THE INVENTION

Methods for the preparation of beverages, like tea beverages, are known. For example, many food establishments have brewing systems that dispense tea-based beverages ready for consumption. Typically, such systems operate by mixing a tea extract or component with hot water to produce a hot composition that is subsequently combined with cold water and ice to thereby produce a cold tea beverage that is ready to drink.

Unfortunately, however, when preparing such tea beverages, the tea beverages that are produced by conventional tea brewing systems are not always homogeneous. For instance, many conventional tea-brewing systems produce tea beverages that are hazy and/or have suspended therein, particles of undissolved extract. Tea beverages with undissolved particles do not look very desirable to the consumer, and almost invariably, do not taste as good as a substantially homogenous tea-based beverage (i.e., a tea beverage having fully dissolved extract). Moreover, conventional beverage systems are not suitable to dispense beverage that has a homogeneous look throughout the duration of the dispensing period. In fact, typical beverage systems, when dispensing a serving, release very dark then light beverage, causing the consumer to often question the taste and freshness of the dispensed beverage.

It is of increasing interest to develop a beverage system and method for dispensing a beverage that result in a substantially homogeneous beverage. This invention, therefore, is directed to a beverage system for dispensing a homogeneous beverage and method for dispensing a beverage that employ a mixing chamber for mixing beverage precursor and heated solvent whereby the mixing within the mixing chamber is the result of turbulent flow created within the same.

### ADDITIONAL INFORMATION

Efforts have been disclosed for making beverages. In U.S. Pat. No. 5,529,796, a process for making ready to drink tea is described.

Other efforts have been disclosed for dispensing beverages. In U.S. Pat. No. 6,135,009, a beverage system on a serving cart assembly is described.

Still other efforts have been disclosed for dispensing beverages. In World Application WO 01/65985, a device having automatic and semi-automatic brewing modes is described.

Even other efforts have been disclosed for making beverages. In European Patent No. 0 552 519 B1, improvements directed at tea processing are described.

Moreover, in World Application No. WO 2004/094585 A2 and U.S. Patent Publication No. 2006/0006195 A1, devices for preparing tea-based beverages are described.

None of the additional information above describes a beverage system or method for dispensing a beverage wherein precursor and solvent are mixed in a mixing chamber with turbulent flow created by solvent within the same.

### SUMMARY OF THE INVENTION

In a first aspect, the present invention is directed to a beverage brewing system comprising:
(a) a conduit for supplying heated solvent;
(b) a conduit for supplying beverage precursor;
(c) a conduit for supplying solvent that has not been heated; and
(d) optionally, at least one conduit for supplying aroma, flavor and/or sweetener
   wherein the conduits are connected to a mixing chamber for mixing the heated solvent, beverage precursor, unheated solvent, and optionally aroma, flavor and/or sweetener with turbulent flow created by the heated solvent, unheated solvent or both and within the mixing chamber.

In a second aspect, the present invention is directed to a method for brewing a beverage with the system of the first aspect of this invention.

In a third aspect, the present invention is directed to a beverage made via the method for brewing the beverage of the second aspect of the invention.

In a fourth aspect, the present invention is directed to the mixing chamber used in the beverage brewing system of this invention.

Beverage, as used herein, is defined to mean a liquid composition that a consumer may drink, either hot or cold. Beverage, therefore, is meant to include liquid compositions like coffee-based beverages, chocolate-based beverages, soup, and especially, tea-based beverages. Homogeneous beverage is defined to mean beverages with essentially no visible particles of undissolved extract or precursor, and therefore, often an essentially translucent beverage. Beverage precursor is meant to include an anhydrous or hydrous product that results in a beverage when combined with solvent. Beverage precursor is meant to include a composition suitable to be combined with a solvent to produce a beverage, and preferably, includes tea extracts or concentrates with or without carbohydrates and similar to those described in U.S. Pat. No. 6,413,570, the disclosure of which is incorporated herein by reference. Associated with is defined to mean having a means for joining or connecting to.

### BRIEF DESCRIPTION OF THE DRAWINGS

The subject matter which is regarded as the invention is particularly pointed out and distinctly claimed in the concluding portions of the specification. The invention, however, may be best understood by reference to the following description taken in conjunction with the accompanying drawing figures in which:

FIG. 1 is a drawing of a type of brewing machine that can comprise the brewing system of the present invention;

FIG. 2 is an illustrative schematic drawing of the brewing system of the present invention; and

FIG. 3 is an illustrative mixing chamber suitable for use in this invention.

### DETAILED DESCRIPTION OF THE PREFERRED EMBODIMENTS

There is no limitation with respect to the type of heated solvent that may be used in this invention other than that the heated solvent is one which may be used in a beverage suitable for human consumption. Such a heated solvent typically includes milk, juice, broth, water, mixtures thereof or the like, whereby water is the often preferred heated solvent.

Regarding the temperature of the heated solvent used in the present invention, typically, the temperature is from about 40° C. to about 100° C., and preferably, from about 45° C. to about 95° C., including all ranges subsumed therein.

The conduit for supplying the heated solvent is limited only to the extent that the conduit can carry or supply the heated solvent in a beverage brewing system. Such a conduit may be made of materials comprising copper, galvanized metal, polycarbonate, polyamide, polyester, olefins, stainless steel or the like. In a most preferred embodiment, however, the conduit for supplying the heated solvent is stainless steel, whereby the diameter of the conduit is from about 0.2 cm to about 2 cm, and preferably, from about 0.3 cm to about 1.5 cm, and most preferably, from about 0.4 cm to about 1.3 cm, including all ranges subsumed therein.

The beverage precursor that may be used in the beverage brewing system of the present invention is limited only to the extent that it is one which may be used to make a beverage suitable for human consumption whereby the same, again, may be anhydrous or hydrous. Such a precursor can be one that is used to make a fruit flavored beverage such as lemonade; a soup, like chicken soup; coffee; hot chocolate or a tea-based beverage. In an especially preferred embodiment, however, the precursor is one which may be used to make a tea-based beverage whereby the precursor (e.g., one which is preferably at least about 50.0% by weight solids) for making the tea-based beverage is made available from suppliers like Unilever Foods, under the general category of Lipton® Tea Extracts or Concentrates. Moreover, the precursor (within the beverage brewing system) is typically at a temperature from about 15 degrees centigrade to about 100 degrees centigrade, and preferably, from about 20 degrees centigrade to about 60 degrees centigrade, and most preferably, from about 22 degrees centigrade to about 35 degrees centigrade before beverage is made and including all ranges subsumed therein.

Regarding the conduit that may be used to supply or deliver the beverage precursor of the present invention, such a conduit is made of materials similar to the ones described for delivering the heated solvent. In an especially preferred embodiment, however, the conduit that supplies the beverage precursor has an outside diameter that is less than the inside diameter of the conduit for supplying heated solvent.

The solvent that has not been heated is typically any liquid that may be used in a beverage. Preferably, the liquid is water and at a temperature from about 2.0 degrees centigrade to less than 40 degrees centigrade, and most preferably, water at about the temperature of tap water. As to the conduit that may be used to supply or deliver solvent that has not been heated, such a conduit is also made of materials similar to those described for delivering the heated solvent.

The aroma and/or flavor component that may optionally but preferably be used in the present invention is preferably derived from tea and used to enhance the quality of the beverage being dispensed. Such a component is often complex, consisting of approximately 500-650 compounds that include hydrocarbons, aldehydes, alcohols, esters, ketones, lactones, phenols, acids and nitrogen- and sulfur-containing compounds and the like. A list of illustrative compounds is presented in “Tea, Cultivation to Consumption”, Wilson and Clifford, Chapman Hall, London (1992), the disclosure of which is incorporated herein by reference. Such a component is also made commercially available under the Lipton® brand name by Unilever Foods.

As to the sweetener suitable for use in this invention, any commonly known natural or artificial sweetener may be used wherein the preferred sweetener is one which is a liquid and aqueous-based.

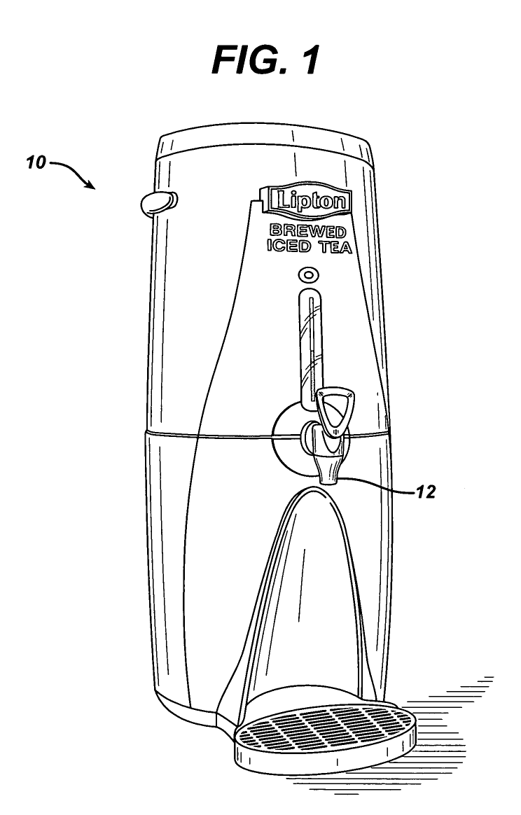

Turning to the figures, FIG. 1 shows a beverage brewing machine 10 comprising the beverage brewing system (not shown) of the present invention. The beverage brewing machine 10 may be used, for example, to dispense a tea-based beverage (not shown) from exit port 12.

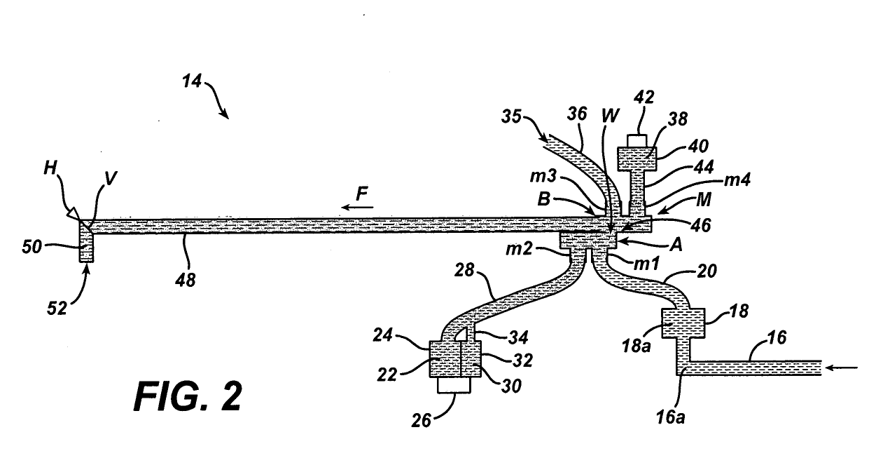

FIG. 2 depicts an illustrative schematic diagram of the brewing system 14 of the present invention which may be found within the beverage brewing machine 10, the brewing system 14 being fed solvent from, for example, a storage container having a pump or from tap (both not shown). Solvent feed conduit 16 supplies, for example, feed solvent 16a to solvent heater tank 18 to produce heated solvent 18a. Conduit for supplying heated solvent 20 joins mixing chamber M at, for example, first mixing chamber junction m1. Beverage precursor 22, in precursor reservoir 24, is pumped, optionally but preferably by food grade pump 26 through conduit for supplying precursor 28 which joins, for example, mixing chamber M at second mixing chamber junction m2. Optionally, aroma and/or flavor compounds 30 may be pumped from enhancer reservoir 32 via, for example, food grade pump 26 and through enhancer conduit 34 to join beverage precursor 22 within conduit for supplying precursor 28. Non-heated solvent 35 (supplied from a storage container having a pump, or tap, (both not shown)) is supplied via non-heated solvent conduit 36 to mixing chamber M at, for example, third mixing chamber junction m3. Optionally, sweetener 38 in sweetener reservoir 40 is pumped via sweetener pump 42, though sweetener conduit 44, to mixing chamber M at, for example, fourth mixing chamber junction m4.

A mixture 46, comprising heated solvent, unheated solvent, extract and optionally aroma, sweetener and/or flavor, is made within mixing chamber M via turbulent liquid flow and superior mixing within the mixing chamber. Preferably, therefore, the heated solvent and unheated solvent enter into the mixing chamber M at separate mixing chamber housings A and B connected by a common mixing window W which allows for mixing and the creation of turbulent liquid flow. While it is within the scope of this invention for mixing chamber M to take on any orientation and for conduits to insert or connect to the same at any place and orientation, it is, again, preferred that heated solvent and unheated solvent enter into the mixing chamber at separate mixing chamber housings A and B (and respectively as illustrated). It is also preferred that the solvents enter the mixing chamber from opposite directions and about perpendicular to the flow F of mixture 46 coming out of the mixing chamber M, where about perpendicular is defined to mean at about an angle from about 45° to about 90°, but preferably, from about 80° to about 90°. In an especially preferred embodiment, heated solvent 18a and beverage precursor 22 enter the mixing chamber M at a point lower than unheated solvent 35. In yet another especially preferred embodiment, the weight ratio of non-heated solvent to heated solvent within the mixing chamber is from about 5 to 20:1, and preferably, from about 6 to 15:1, and most preferably, from about 8 to 12:1. It should be understood that mixing window is defined to include a hole, connection or channel that allows for the combination of heated and unheated solvent.

When demanding a beverage, a valve V, for example, is opened by moving valve opener H of the brewing system 14. Mixture 46 travels out of mixing chamber M through beverage exit conduit 48 (preferably located on mixing chamber housing B when unheated solvent is provided to the same), resulting in a beverage 50 to be dispensed at opening 52 by way of exit port 12. When the beverage 50 is a tea-based beverage, the same is preferable from about 0.2 to about 0.4% by weight tea solids.

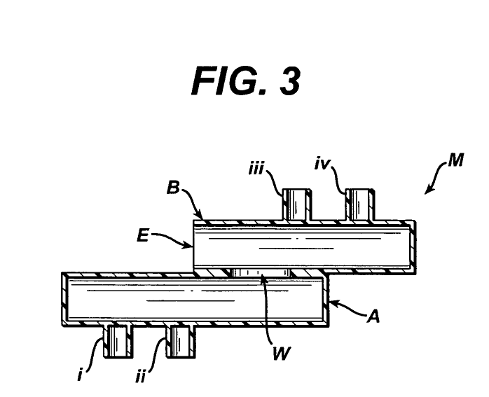

Turning to FIG. 3, shown is a cross-section of an illustrative mixing chamber M suitable for use in this invention. Illustrative mixing chamber junctions i, ii, iii and iv are shown at optional points and orientations. Mixing window W is shown as a channel opening between the two mixing chamber housings A and B. Contents within the mixing chamber M (not shown) may exit the mixing chamber M at exit pore E (suitable for connecting to beverage exit conduit 48) and optionally shown on the anterior portion of mixing chamber housing A. It should also be understood that while the mixing chamber M depicted by FIG. 3 has two (2) mixing chamber housings A and B, one (1) mixing window W and four (4) mixing chamber junctions i-iv, it is within the scope of this invention to have a plurality of housings, as well as a plurality of mixing windows and mixing chamber junctions.

The example below is provided to illustrate an understanding of the present invention. The example is not intended to limit the scope of the claims.

### EXAMPLE

Tea-based beverages having about 0.25% by weight tea solids were dispensed from a beverage brewing machine similar to the one shown in FIG. 1 whereby the beverage brewing machine 10 had a brewing system similar to the brewing system 14 illustrated in FIG. 2 and a mixing chamber similar to the mixing chamber M illustrated in FIG. 3. The tea-based beverages made according to this invention were compared to similar tea-based beverages made in conventional beverage brewing machines having a laminar flow and linear mixing chamber.

Approximately one hundred and eighty (180) ready-to-drink tea-based beverages were dispensed, ninety (90) from an apparatus comprising the beverage brewing system of this invention and ninety (90) from a conventional beverage brewing machine. About ten (10) panelists observed the beverages as they were being dispensed. The panelists unanimously concluded that the beverages dispensed from the apparatus comprising the beverage system of this invention were all homogeneous in characteristics (including color) whereby all control beverages dispensed from the conventional machine were dark in color and then light in color during the dispensing period.

Hunter Haze Values were taken with a Hunter Haze Colorimeter for all samples made. The tea-based beverages made according to this invention had haze values that ranged from about 5 to about 20 percent lower than the haze values for the controls.

The results demonstrate that beverages made according to this invention, unexpectedly, display less haze and are of homogeneous characteristics when being dispensed. The panelists also concluded that the beverages made according to this invention had better taste characteristics when compared to the controls.

What is claimed is:

1. A beverage brewing system comprising
(a) a conduit for supplying heated solvent;
(b) a conduit for supplying beverage precursor;
(c) a conduit for supplying solvent that has not been heated; and
(d) optionally, at least one conduit for supplying aroma, flavor and/or sweetener
wherein the conduits are connected to a mixing chamber for mixing the heated solvent, beverage precursor, unheated solvent, and optionally aroma, flavor and/or sweetener with turbulent flow created by the heated solvent, unheated solvent or both and within the mixing chamber.

2. The beverage brewing system according to claim 1 wherein the mixing chamber comprises at least two mixing chamber housings connected internally by a mixing window.

3. The beverage brewing system according to claim 1 wherein the conduit for supplying heated solvent is associated with a first mixing chamber housing of the mixing chamber and the conduit for supplying solvent that has not been heated is associated with a second mixing chamber housing of the mixing chamber, wherein the first mixing chamber housing is at a point which is lower than the second mixing chamber housing, and further wherein the chambers have a common window for solvent mixing.

4. The beverage brewing system according to claim 1 wherein the beverage precursor is a precursor for coffee-based beverages, chocolate-based beverage, soup or tea-based beverages.

5. The beverage brewing system according to claim 1 wherein the beverage precursor is a precursor for tea-based beverages.

6. The beverage brewing system according to claim 3 wherein the beverage precursor is provided via a conduit that is associated with the first mixing chamber housing.

7. A method for making a beverage comprising the steps of:
(a) providing a heated solvent to a mixing chamber within a beverage dispensing machine, the heated solvent being provided via a conduit associated with to a first mixing chamber housing of the mixing chamber;
(b) providing, via a conduit, a solvent that has not been heated to a second mixing chamber housing of the mixing chamber;
(c) delivering beverage precursor to the mixing chamber;
(d) mixing the beverage precursor and solvents with turbulent flow within the mixing chamber; and
(e) recovering a beverage.

8. The method for making a beverage according to claim 7 wherein the first mixing chamber housing is at a point lower than the second mixing chamber housing.

9. The method for making a beverage according to claim 7 wherein the beverage is recovered from a conduit associated with the second mixing chamber housing.

10. The method for making a beverage according to claim 7 wherein aroma, flavor, sweetener or a combination thereof is provided to the mixing chamber.

11. The method for making a beverage according to claim 7 wherein the beverage precursor is a precursor for coffee-based beverages, chocolate-based beverage, soup or tea-based beverages.

12. The method for making a beverage according to claim 7 wherein the beverage precursor is a precursor for tea-based beverages.

13. The method for making a beverage according to claim 7 wherein the solvent that has not been heated and heated solvent are at a weight ratio from about 5 to 20:1.

14. The method for making a beverage according to claim 12 wherein the tea-based beverage is from about 0.2 to about 0.4% by weight tea solids.

15. A tea-based beverage made by the method of claim 7.

16. A mixing chamber comprising:
(a) a plurality of housings;
(b) at least one window between each housing; and
(c) a plurality of mixing chamber junctions wherein mixing within the mixing chamber is the result of turbulent solvent flow.
